(19) United States
(12) Patent Application Publication
(10) Pub. No.: US 2008/0110029 A1
(43) Pub. Date: May 15, 2008

(54) Knives with wire cutter

(75) Inventors: Steven T. Ryan, Westminster, CA (US); Craig C. Stevens, Dove Canyon, CA (US)

Correspondence Address: DAVID WEISS, 12650 RIVERSIDE DRIVE, SUITE 100, NORTH HOLLYWOOD, CA, 91607-3442, US

(73) Assignee: SUREFIRE, LLC

(21) Appl. No.: 11/280,041

(22) Filed: Nov. 15, 2005

(51) Int. Cl. B26B 3/06; F41B 13/02

(52) U.S. Cl. 30/155

(57) ABSTRACT

Combined knife and wire cutter apparatus including both fixed blade knife and folding knife embodiments. Both such embodiments comprise an elongate handle including at least one notch along an edge thereof for receiving a segment of a wire; and an elongate member pivotably secured to the handle and having a first end portion and a second end portion, the elongate member pivotable about a pivot axis in a first rotational direction with the first end portion moving away from the handle and in a second rotational direction with the first end portion moving toward the handle, the second end portion including a cutting edge situated for traversing the at least one notch when the elongate member is pivoted about the pivot axis.

### BACKGROUND OF THE INVENTION

This invention relates to knives, and more particularly to knives having a wire cutting capability.

It is not uncommon for military personnel involved in combat operations to encounter situations where it is necessary to cut wires, such as barbed wire included in fences and other structures. Although wire cutting tools such as a pliers with a wire cutting capability would, of course, capably perform this function, it is usually impractical for military personnel to carry such tools on their person into combat.

One tool normally carried into combat, however, is a knife for being used as a weapon in hand-to-hand combat and for other purposes related to the user's survival. Combat knives may be either of the fixed blade type wherein the knife blade is fixedly secured to the knife's handle, or of the folding type wherein the knife blade is pivotally secured to the handle such that the blade is pivotably movable between a closed position with its sharp edge contained by the handle and an open position with its sharp edge outside the handle and ready for use. Such knives equipped with a wire cutting capability would make unnecessary the carrying into combat of a separate wire cutting tool while permitting the knife carrier the option to cut wires when a wire cutting opportunity arises.

Tools combining a knife and a wire cutter are known in the art. For example, U.S. Pat. No. 5,826,338 to Chilton et al. and U.S. Pat. No. 6,412,130 to Kershaw et al. each disclose a multipurpose tool including a double handled pliers having a jaw with a wire cutting capability, such tool also including a folding knife blade housed in one of the pliers' handles. U.S. Pat. No. 5,226,237 to Rancour et al. teaches a scissors-type knife and wire cutter combination having two handles and including a double-edged knife for cutting flexible duct insulation and a wire cutter for cutting wire embedded in the duct insulation. Combination knives and wire cutters of the types described in the Chilton et al., Kershaw et al. and Rancour et al. patents would not appear to be adaptable to combat operations. U.S. Pat. No. 4,720,030 to Petrovich teaches a multipurpose bayonet system in which wire cutting jaws are built into the distal end of a scabbard housing the fixed blade of a bayonet/combat knife.

In view of this background, it is apparent that there exists a long felt need for combat knives directly incorporating an easily employable wire cutting capability.

### SUMMARY OF THE INVENTION

The present invention fulfills this need by providing both a fixed blade knife and a folding knife each of which directly incorporates an easily employable wire cutting capability, the combined knife and wire cutter being of particular utility for military personnel in combat situations as well as by hunters in hunting environments.

According to one aspect of the present invention, there is provided knife apparatus comprising: an elongate handle including at least one notch along an edge thereof for receiving a segment of a wire; and an elongate member pivotally secured to the handle and having a first end portion and a second end portion, the elongate member pivotable about a pivot axis in a first rotational direction with the first end portion moving away from the handle and in a second rotational direction with the first end portion moving toward the handle, the second end portion including a cutting edge situated for traversing the at least one notch when the elongate member is pivoted about the pivot axis. The at least one notch and the cutting edge are configured for cutting the wire when the segment of the wire is received by the at least one notch and the elongate member is pivoted to traverse the cutting edge across the at least one notch.

The present invention may be embodied in a fixed blade knife, wherein the knife apparatus includes a knife blade fixedly secured to the handle.

In another preferred embodiment, a folding knife is provided wherein the pivotally secured elongate member comprises the pivotally secured knife blade.

A preferred fixed blade knife embodiment according to the present invention comprises: an elongate handle including a notch along an edge thereof for receiving a segment of a wire; a knife blade fixedly secured to the elongate handle; and an elongate member pivotally secured to the handle and having a first end portion and a second end portion, the elongate member pivotable about a pivot axis (preferably in the vicinity of the second end portion) in a first rotational direction with the first end portion moving away from the handle and in a second rotational direction with the first end portion moving toward the handle, the second end portion including a cutting edge situated for traversing the notch when the elongate member is pivoted about the pivot axis. The notch and the cutting edge are configured for cutting the wire when the segment of the wire is received by the notch and the elongate member is pivoted in the second direction to traverse the cutting edge across the notch. The cutting edge is preferably included by a notch along an edge of the elongate member for receiving the segment of the wire when the segment is received by the notch in the handle.

A preferred folding knife embodiment of the present invention comprises: an elongate handle including two laterally spaced-apart side scales, each of the scales including a front end portion having a notch along an edge thereof, the notches in the scales laterally aligned with one another for receiving a segment of a wire; a knife blade having a distal end and a tang, the tang pivotally secured to the handle between the scales, the knife blade pivotable about a pivot axis in a first rotational direction with the blade's distal end moving away from the handle and in a second rotational direction with the blade's distal end moving toward the handle, the tang including a cutting edge situated for traversing the aligned notches in the scales when the knife blade is pivoted about the pivot axis. The notches in the scales and the cutting edge are configured for cutting the wire when the segment of the wire is received by the notches and the knife blade is pivoted in the second direction to traverse the cutting edge across the notches. The cutting edge is preferably included by a notch along an edge of the blade's tang for receiving the segment of the wire when the segment is received by the notches in the scales.

### BRIEF DESCRIPTION OF THE DRAWINGS

The novel features believed to be characteristic of the present invention, together with further advantages thereof, will be better understood from the following description considered in connection with the accompanying drawings in which preferred embodiments of the invention are illustrated by way of example. It is to be expressly understood, however, that the drawings are for the purpose of illustration and description only and are not intended as a definition of the limits of the invention.

FIG. 1 is right side elevation view of a preferred embodiment of a knife with wire cutter apparatus in accordance with the present invention, specifically an example of a fixed blade knife;

FIG. 2 is a bottom plan view of the knife/wire cutter embodiment shown in FIG. 1;

FIG. 3 is a left side elevation view of the knife/wire cutter embodiment of FIG. 1;

FIG. 4 illustrates the knife/wire cutter embodiment of FIG. 3 during use as a wire cutter;

FIG. 5 is a right side elevation view of a second preferred embodiment of a knife with wire cutter apparatus according to the present invention, specifically an example of a folding knife shown in its closed or folded condition;

FIG. 6 is a left side elevation view of the closed folding knife/wire cutter embodiment of FIG. 5;

FIG. 7 is a right side elevation view of the folding knife/wire cutter embodiment of FIG. 5, the knife being shown in its fully open or unfolded condition;

FIG. 8 is a top plan view of the knife/wire cutter embodiment shown in FIG. 7;

FIG. 9 is an exploded right side view of the folding knife/wire cutter embodiment shown in FIG. 5, illustrating placement of the knife blade with the left and right side scales of the knife's handle; and

FIG. 10 illustrates the folding knife/wire cutter embodiment of FIG. 5 during use as a wire cutter.

### DETAILED DESCRIPTION OF THE PREFERRED EMBODIMENTS

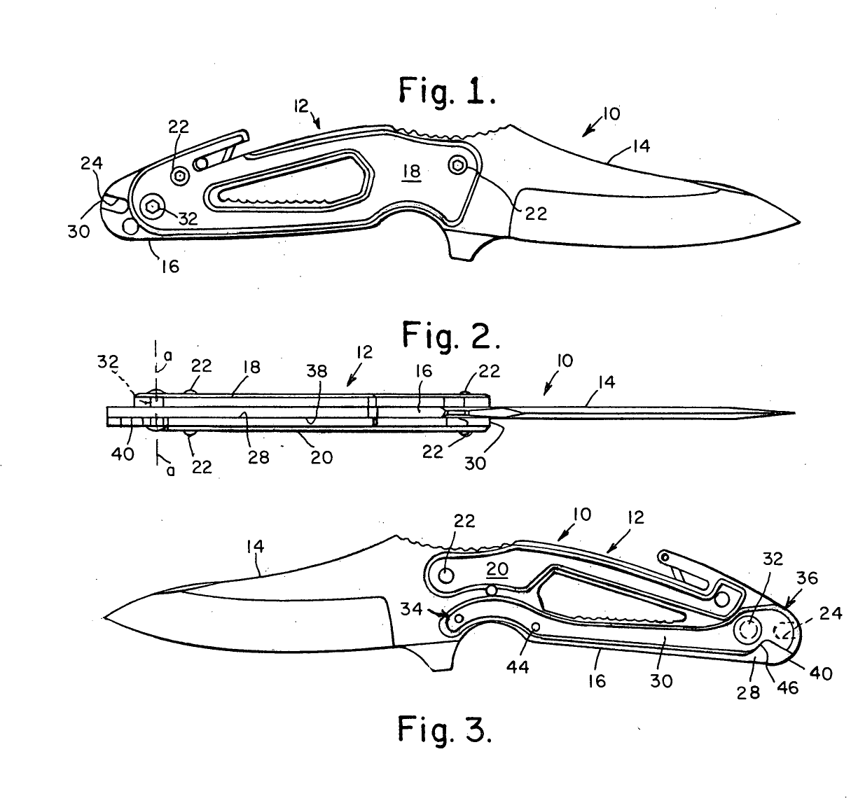

FIGS. 1-4 show a preferred embodiment of a knife with wire cutter apparatus according to the present invention, which embodiment includes a fixed blade knife, i.e. a knife 10 having an elongate handle 12 and a knife blade 14 fixedly secured to the handle 12. In the illustrated embodiment, the handle 12 is configured as an elongate platelike rearward extension 16 of the blade 14, to which a right side grip or scale 18 and a left side grip or scale 20 may be secured as by rivets 22.

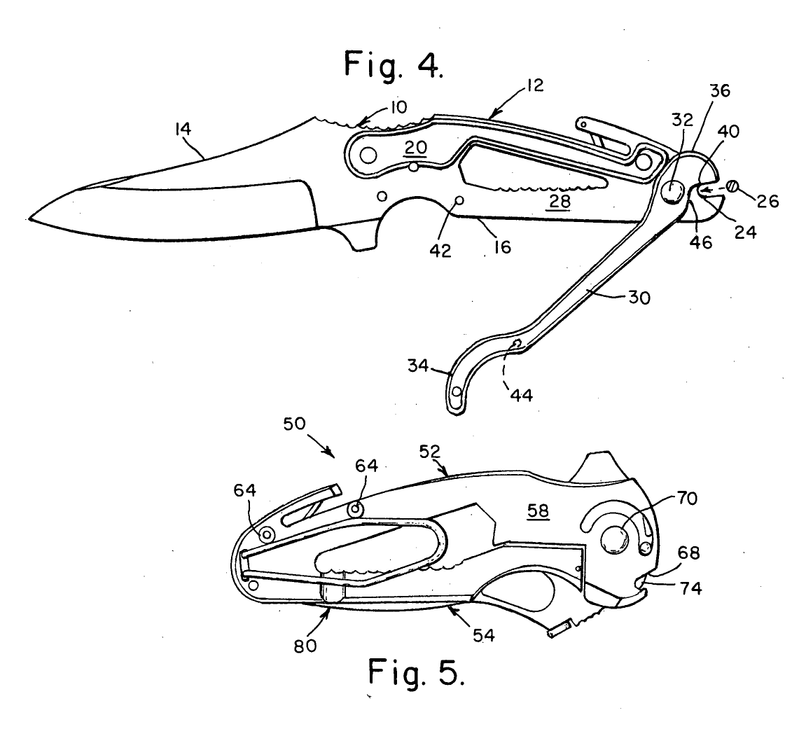

The knife 10 includes a wire cutting mechanism involving cooperation between the handle 12 and an elongate member pivotally secured to the handle. The handle 12 includes a notch 24 along an edge thereof for receiving a segment of a wire 26, the wire 26 being represented in cross-section in FIG. 4. The notch 24 is preferably situated in the vicinity of the rear end of the handle 12, extending through a substantially flat surface portion 28 of the handle 12 (e.g., the flat surface portion 28 of the left side of the handle's elongate platelike extension 16).

As best shown in FIGS. 2-4, the elongate member of the illustrated embodiment comprises a rigid arm 30 pivotally secured to the handle 12 by a headed pivot 32 having a pivot axis a laterally extending through the elongate handle 12, preferably perpendicular to and extending through the flat surface portion 28. The arm 30 includes a first or front end portion 34 and a second or rear end portion 36, and the pivot 32 is situated preferably substantially closer to the second end portion 36 than to the first end portion 34 (preferably in the vicinity of the second end portion 36). The arm 30 includes a flat surface 38 on its reverse side facing the handle's flat surface portion 28 with at least the included flat surface of the second end portion 36 being in rotatably sliding engagement with the handle's flat surface portion 28. The arm's second end portion 36 includes a cutting edge 40 situated for traversing the handle's notch 24 when the arm 30 is pivoted about the pivot 32, such as when a user urges the arm's first end portion 34 in a first rotational direction away from the handle 12 (counterclockwise as viewed in FIG. 3) from its normal or closed position shown in FIG. 3 to an open position as shown in FIG. 4, and when a user urges the first end portion 34 in a second rotational direction toward the handle 12 (clockwise as viewed in FIG. 4) from the arm's open position shown in FIG. 4 to its normal or closed position shown in FIG. 3.

The arm 30 is preferably releasably retained in its normal or closed position along the handle 12, for example by means of a detent mechanism such as a laterally biased projection 42 (FIG. 4) on the handle's flat surface portion 28 releasably mating with a recess 44 (shown in phantom in FIGS. 3 and 4) on the reverse side of the arm 30. When the arm 30 is pivoted to its open condition, an edge of the arm's second end portion 36 preferably contacts a rear edge portion of the scale 20 which acts as a stop for preventing counterclockwise rotation of the arm 30 in substantial excess of the rotation required for permitting the cutting edge 40 to completely traverse the notch 24.

In a preferred configuration, the cutting edge 40 is included by a notch 46, i.e. the cutting edge 40 comprises at least a portion of the notch 46.

When using the knife 10 as a wire cutter, a user grasps the knife handle 12 and releases the first end portion 34 of the arm 30 (such as by urging the first end portion 34 away from the handle 12 with his/her thumb). He/she continues to urge the first end portion 34 to move away from the handle 12 for pivoting the arm 30 in the first or counterclockwise direction about the pivot 32, or he/she simply permits such movement by gravity, until the cutting edge 40 of the arm's second end portion 36 traverses across the notch 24 in the handle 12. At this point, the user places the knife 10 to the wire 26, or alternatively places the wire 26 to the knife 10, such that a segment of the wire 26 is transversely received by the notch 24 and, in the embodiment shown, by the notch 46, as represented in FIG. 4. The user thereupon urges the arm's first end portion 34 toward the handle 12 (such as with one or more of his/her fingers of the same hand holding the knife handle 12), thereby pivoting the arm 30 about the pivot 32 toward the handle 12 in the second or clockwise direction, causing the cutting edge 40 of the arm's second end portion 36 to cut through the wire segment 26 as the cutting edge 40 traverses across the notch 24.

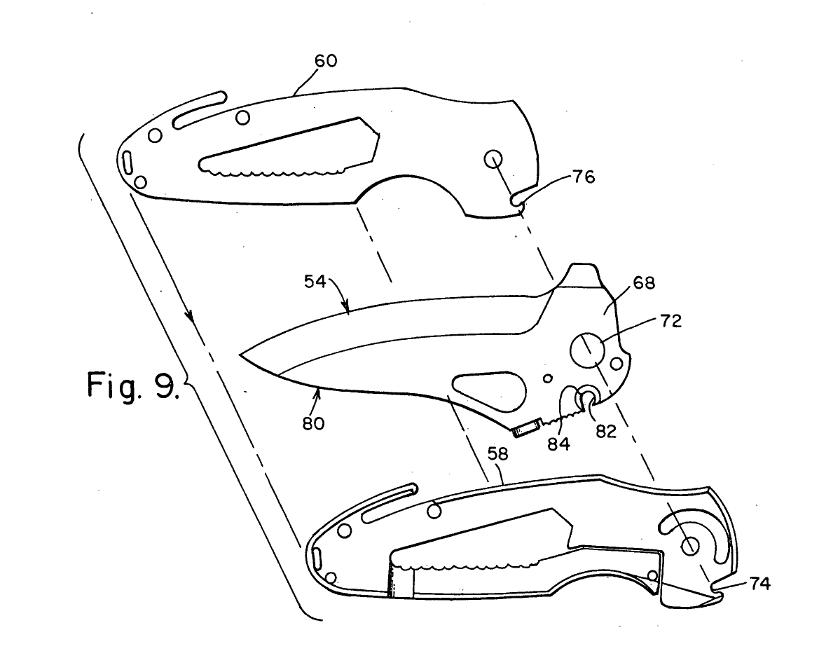

Turning to FIGS. 5-10, there is shown a second preferred embodiment of a knife with wire cutter apparatus according to the present invention, which embodiment includes a folding knife, specifically a knife 50 having an elongate handle 52 and a knife blade 54 pivotally secured to the handle 52 such that the blade 54 is pivotally movable between a closed position with its sharp edge 56 contained by the handle 52 (FIG. 5) and an open position with its sharp edge 56 outside the handle 52 and ready for use (FIG. 7).

As is typical in the art, the handle 52 of the folding knife 50 comprises a right side plate or scale 58 and a left side plate or scale 60 secured opposite one another but laterally spaced apart by a rear spacer 62 and rivets 64, forming a channel 66 between the scales 58, 60 for accommodating the knife blade 54. The knife blade 54 includes a tang 68 at its proximal end situated between the two scales 58, 60 and pivotally secured to the handle by a headed pivot 70 having a pivot axis a′ laterally extending through the two scales 58, 60 of the handle 52, the pivot 70 being concentric with a bore 72 in the blade's tang 68.

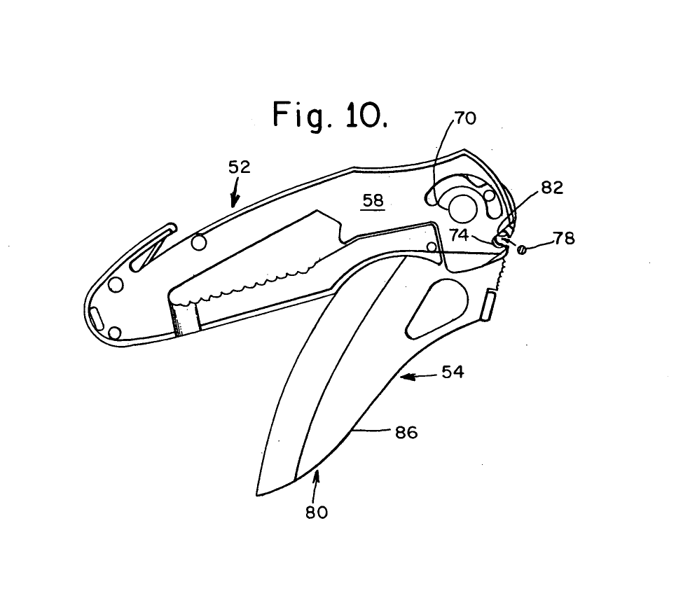

In accordance with the present invention, the folding knife embodiment 50 includes a wire cutting mechanism involving cooperation between the handle 52 and the elongate knife blade 54 pivotally secured to the handle 52. In the illustrated embodiment, the handle's right side scale 58 includes a notch 74 along an edge thereof, and the left side scale 60 includes a notch 76 along an edge thereof. The two notches 74, 76 are laterally aligned in the assembled handle 52 and are situated and configured to receive a segment of a wire 78 (the wire 78 being represented in cross-section in FIG. 10), the notches 74, 76 preferably being substantially congruent at least to the extent required for permitting the wire to be received by both notches 74, 76 and cut as described herein. The notches 74, 76 are preferably situated in the vicinity of the front end of the handle 52, preferably along a front edge thereof.

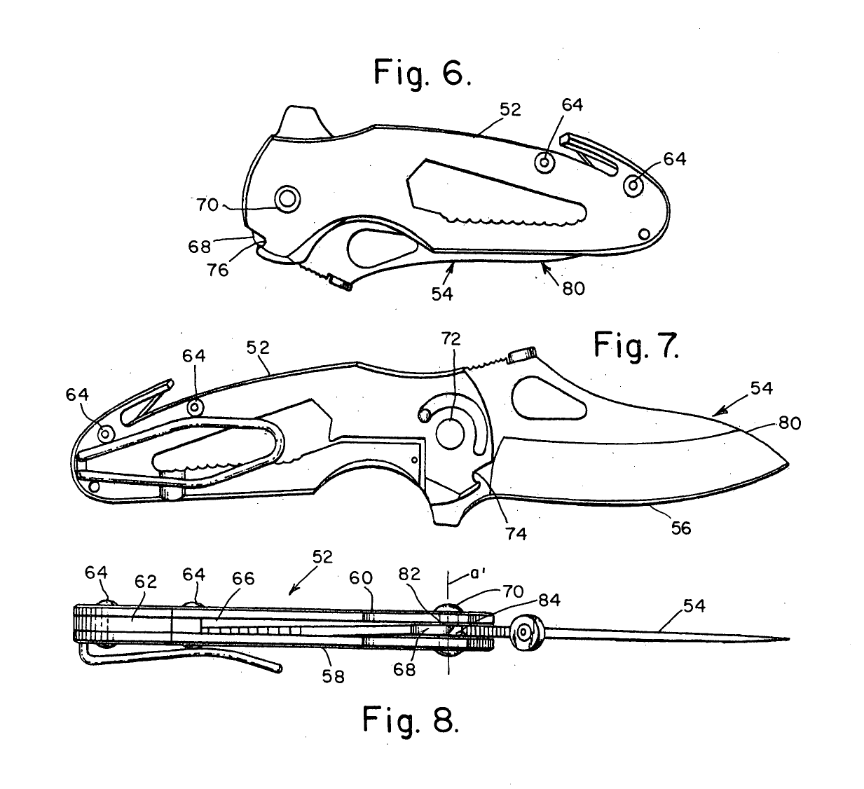

The knife blade 54 includes a first or front end portion 80 (toward the blade's distal end or the front of the knife blade 54 in its open condition) and a second or rear end portion comprising the tang 68. The tang 68 includes a cutting edge 82, preferably included in a notch 84 along the tang's edge, situated for traversing the handle's aligned notches 74, 76 in the scales 58, 60 on either side of the blade 54 when the blade 54 is pivoted about the pivot 70. Such pivoting may be accomplished by a user urging the blade 54 from its closed position in the handle 52 such that the blade's first end portion 80 moves away from the handle 52 in a first rotational direction (counterclockwise as viewed in FIGS. 5 and 10, clockwise as viewed in FIG. 6), from the blade's folded or closed position shown in FIGS. 5 and 6 to a partially open position as shown in FIG. 10. Such pivoting is also accomplished by the user urging the blade 54 for moving the first end portion 80 of the knife blade 54 toward the handle 52 in a second rotational direction opposite the first rotational direction (clockwise as viewed in FIGS. 7 and 10) from the blade's partially open position shown in FIG. 10 to its closed position shown in FIG. 5.

When using the folding knife as a wire cutter, a user grasps the knife handle 52 and urges the knife blade 54 from its closed position such that the blade's first end portion 80 moves away from the handle 52 for pivoting the blade 54 in the first rotational direction about the pivot 70, until the cutting edge 82 of the blade's second end portion or tang 68 traverses across the aligned notches 74, 76 in the handle 52, i.e. until the notch 84 in the tang 68 is laterally aligned with the two notches 74, 76 in the scales 58, 60. At this point, the user places the knife 50 to the wire 78, or alternatively places the wire to the knife 50, such that a segment of the wire 78 is transversely received by the three aligned notches 74, 76, 82, as represented in FIG. 10. The user thereupon urges the knife blade 54 for moving its first end portion 80 toward the handle 52 (such as by pressing against the blunt back edge 86 of the knife blade 54 with one or more fingers of the same hand used to hold the knife handle 52). The knife blade 54 is thereby pivoted about the pivot 70 in the second direction toward the handle 52, causing the cutting edge 82 of the knife blade's second end portion 68 to cut through the wire segment 78 as the cutting edge 82 traverses across the notches 74, 76.

The various components of the disclosed knife embodiments may be manufactured using fabrication methods well known in the art, of well known materials typically used in the knife weaponry art. For example, with respect to the fixed blade knife embodiment, the knife blade and handle combination is preferably fabricated of steel, as is the pivotable elongate arm, and the grips or scales may be fabricated of metallic or polymeric materials. With respect to the folding knife embodiment, the knife blade is preferably fabricated of steel, and the side scales comprising the handle may be fabricated of metallic materials such as titanium and steel alloys.

Thus, there have been described preferred embodiments of a fixed blade knife and a folding knife each of which directly incorporates an easily employable wire cutting capability, resulting in combined knife and wire cutter apparatus having particular utility for military personnel in combat situations as well as for hunters in hunting environments. Other embodiments of the present invention, and variations of the embodiments described herein, may be developed without departing from the essential characteristics thereof. Accordingly, the invention should be limited only by the scope of the claims listed below.

We claim:

1. Knife apparatus comprising:
an elongate handle including at least one notch along an edge thereof for receiving a segment of a wire; and
an elongate member pivotally secured to said handle and having a first end portion and a second end portion, said elongate member pivotable about a pivot axis in a first rotational direction with said first end portion moving away from said handle and in a second rotational direction with said first end portion moving toward said handle, said second end portion including a cutting edge situated for traversing said at least one notch when said elongate member is pivoted about said pivot axis.

2. The knife apparatus according to claim 1, including:
a knife blade fixedly secured to said handle.

3. The knife apparatus according to claim 1, wherein:
said elongate member comprises a knife blade.

4. The knife apparatus according to claim 1, wherein:
said at least one notch and said cutting edge are configured for cutting the wire when the segment of the wire is received by said at least one notch and said elongate member is pivoted to traverse said cutting edge across said at least one notch.

5. The knife apparatus according to claim 4, including:
a knife blade fixedly secured to said handle.

6. The knife apparatus according to claim 4, wherein:
said elongate member comprises a knife blade.

7. The knife apparatus according to claim 1, wherein:
said at least one notch and said cutting edge are configured for cutting the wire when the segment of the wire is received by said at least one notch and said elongate member is pivoted in said second rotational direction to traverse said cutting edge across said at least one notch.

8. The knife apparatus according to claim 7, including:
a knife blade fixedly secured to said handle.

9. The knife apparatus according to claim 7, wherein:
said elongate member comprises a knife blade.

10. The knife apparatus according to claim 4, wherein:
said cutting edge is included by a notch in said elongate member for receiving the segment of the wire when received by said at least one notch in said handle.

11. The knife apparatus according to claim 10, including:
a knife blade fixedly secured to said handle.

12. The knife apparatus according to claim 10, wherein:
said elongate member comprises a knife blade.

13. The knife apparatus according to claim 4, wherein:
said elongate member comprises a knife blade;
said handle includes two spaced-apart side scales and said knife blade is pivotally secured to said handle between said scales; and
said at least one notch in said handle comprises two laterally aligned notches respectively in said scales.

14. The knife apparatus according to claim 13, wherein:
said cutting edge is included by a notch in said knife blade for receiving the segment of the wire when received by said notches in said scales.

15. The knife apparatus according to claim 5, wherein:
said at least one notch in said handle comprises one notch.

16. The knife apparatus according to claim 15, wherein:
said cutting edge is included by a notch along an edge of said elongate member for receiving the segment of the wire when received by said one notch in said handle.

17. Knife apparatus comprising:
an elongate handle including a notch along an edge thereof for receiving a segment of a wire;
a knife blade fixedly secured to said elongate handle; and
an elongate member pivotally secured to said handle and having a first end portion and a second end portion, said elongate member pivotable about a pivot axis in a first rotational direction with said first end portion moving away from said handle and in a second rotational direction with said first end portion moving toward said handle, said second end portion including a cutting edge situated for traversing said notch when said elongate member is pivoted about said pivot axis.

18. The knife apparatus according to claim 17, wherein:
said pivot axis is in the vicinity of said second end portion.

19. The knife apparatus according to claim 17, wherein:
said notch and said cutting edge are configured for cutting the wire when the segment of the wire is received by said notch and the elongate member is pivoted in said second rotational direction to traverse said cutting edge across said notch.

20. The knife apparatus according to claim 17, wherein:
said cutting edge is included by a notch along an edge of said elongate member for receiving the segment of the wire when received by said notch in said handle.

21. Knife apparatus comprising:
an elongate handle including two laterally spaced-apart side scales, each of said scales including a front end portion having a notch along an edge thereof, the notches of said scales laterally aligned with one another for receiving a segment of a wire;
a knife blade having a distal end and a tang, said tang pivotally secured to said handle between said scales, said knife blade pivotable about a pivot axis in a first rotational direction with said distal end moving away from said handle and in a second rotational direction with said distal end moving toward said handle, said tang including a cutting edge situated for traversing said notches in said scales when said knife blade is pivoted about said pivot axis.

22. The knife apparatus according to claim 21, wherein:
said notches in said scales and said cutting edge are configured for cutting the wire when the segment of the wire is received by said notches and said knife blade is pivoted in said second direction to traverse said cutting edge across said notches.

23. The knife apparatus according to claim 21, wherein:
said cutting edge is included by a notch along an edge of said tang for receiving the segment of the wire when received by said notches in said scales.
